(19) United States
(12) Patent Application Publication
(10) Pub. No.: US 2017/0249083 A1
(43) Pub. Date: Aug. 31, 2017

(54) ELECTRONIC APPARATUS AND CONTROL METHOD THEREOF

(71) Applicant: Realtek Semiconductor Corporation, Hsinchu (TW)

(72) Inventor: Xiao-Xing FEI, JiangSu province (CN)

(21) Appl. No.: 15/196,067

(22) Filed: Jun. 29, 2016

(30) Foreign Application Priority Data
Feb. 25, 2016 (CN) 201610104149.3

(51) Int. Cl. G06F 3/06; G06F 12/02

(52) U.S. Cl. CPC G06F 3/0604; G06F 3/064; G06F 3/0644; G06F 3/0665; G06F 3/0679; G06F 12/0246; G06F 2212/1044; G06F 2212/152; G06F 2212/214; G06F 2212/7206

(57) ABSTRACT

An electronic apparatus includes a flash memory, a memory protection unit, a random access memory, and a central processing unit. The flash memory is configured to store at least one first application program/datum. The memory protection unit is configured to store a plurality of address region data. The random access memory has at least one memory bank. The central processing unit is configured to execute/access the first application program/datum in the flash memory through the random access memory according to at least one address datum. If the address datum matches one of the address region data, the memory protection unit generates an error signal to the central processing unit. The central processing unit loads the first application program/datum stored in the flash memory into the memory bank of the random access memory according to a positioning condition of a matched address region datum.

### RELATED APPLICATIONS

This application claims priority to Chinese Application Serial Number 201610104149.3, filed Feb. 25, 2016, which is herein incorporated by reference.

### BACKGROUND

Technical Field

The present disclosure relates to an electronic apparatus and a control method thereof. More particularly, the present disclosure relates to an electronic apparatus and a control method thereof that utilizes a memory protection unit to expand memory address space.

Description of Related Art

A system on chip (SoC) is an integrated circuit with complete functions, which includes a hardware system and embedded software/firmware. In the design of a system on chip, problems of reliability and low power consumption should be considered at the same time, and many issues that were required to be solved at the system level in the past are gathered up to be solved in the chip level.

In applications of a system on chip, it is necessary to run a large amount of codes in the limited capacity of the random access memory. The current method is mapping addresses through a memory management unit to switch memory banks inside the random access memory so as to effectively utilize the memory.

However, in consideration of the fact that there are still many systems on chips in which no memory management units are disposed, these chips cannot switch memory banks. As a result, the space for running the code is limited only to the capacity of random access memory in the system on chip.

### SUMMARY

An aspect of the present disclosure provides an electronic apparatus. The electronic apparatus includes a flash memory, a memory protection unit, a random access memory, and a central processing unit. The flash memory is configured to store at least one first application program/datum. The memory protection unit is configured to store a plurality of address region data. The random access memory has at least one memory bank. The central processing unit is configured to execute/access the at least one first application program/datum in the flash memory through the random access memory according to at least one address datum. If the at least one address datum matches one of the address region data, the memory protection unit generates an error signal correspondingly to the central processing unit. The central processing unit loads the at least one first application program/datum stored in the flash memory into at least one memory bank of the random access memory according to a positioning condition of a matched address region datum.

Another aspect of the present disclosure provides a control method applicable to an electronic apparatus. The electronic apparatus includes a flash memory, a memory protection unit, a random access memory, and a central processing unit. The control method includes steps as follows. at lest one address datum is compared with a plurality of address region data in the memory protection unit. An error signal is correspondingly generated to the central processing unit if the at least one address datum matches one of the address region data. At least one first application program/datum stored in the flash memory is loaded into at least one memory bank of the random access memory according to a positioning condition of a matched address region datum. The at least one first application program/datum loaded into the random access memory is executed/accessed according to the at least one address datum.

In summary, the objective of the present disclosure is to allow a chip without functions of a memory management unit (MMU) to utilize the property of the memory protection unit so as to expand the memory address space usage.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure. In the drawings,

FIG. 1 depicts a schematic diagram of an electronic apparatus according to one embodiment of the present disclosure;

FIG. 2 depicts a schematic diagram of an electronic apparatus according to one embodiment of the present disclosure;

FIG. 3 depicts a schematic diagram of a control method according to one embodiment of the present disclosure; and

FIG. 4 depicts a schematic diagram of a control method according to one embodiment of the present disclosure.

### DETAILED DESCRIPTION

Reference is made in detail to the present embodiments of the present disclosure, examples of which are illustrated in the accompanying drawings. Wherever possible, the same reference numbers are used in the drawings and the description to refer to the same or like parts.

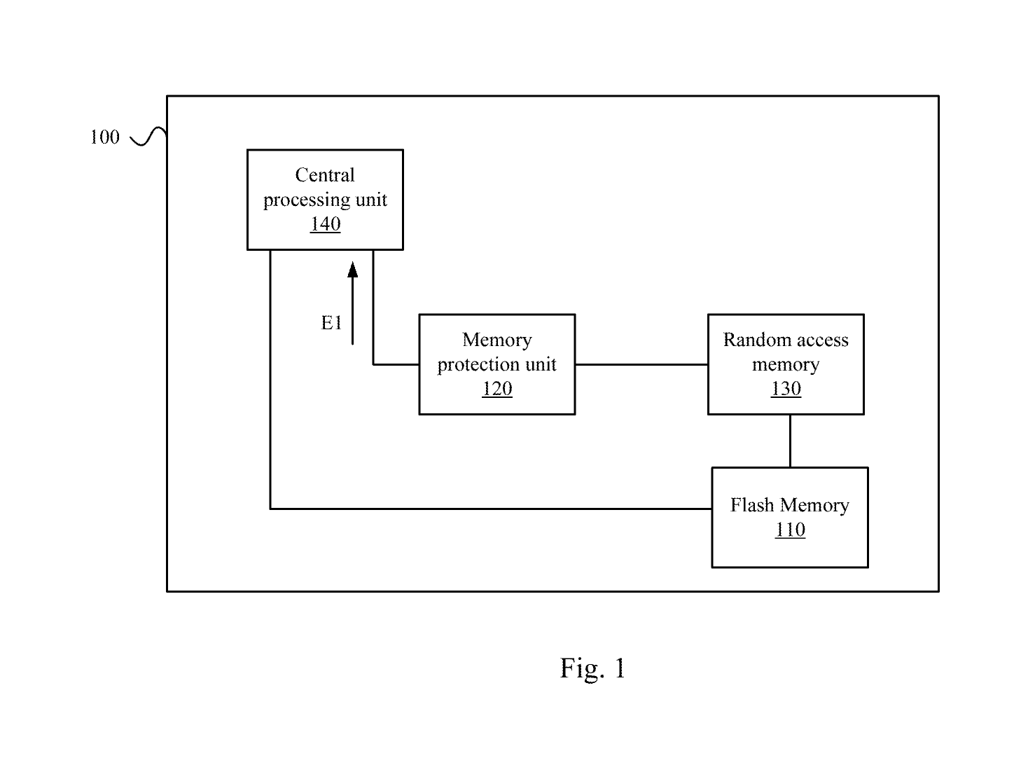

Reference is made to FIG. 1. FIG. 1 depicts a schematic diagram of an electronic apparatus 100 according to one embodiment of the present disclosure. The electronic apparatus 100 may be a system on chip or another equivalent integrated circuit. The electronic apparatus 100 may be applied to a desktop computer, a notebook computer, or a tablet computer, but the present disclosure is not limited in this regard.

The electronic apparatus 100 includes a flash memory 110, a memory protection unit 120, a random access memory 130, and a central processing unit 140. In practical applications, the electronic apparatus 100 may include more arithmetic logic units and/or storage units.

The flash memory 110 is configured to store at least one first application program/datum. The flash memory 110 may be a NAND flash or a NOR flash. In other embodiments, the flash memory 110 may be another memory device such as a non-volatile memory or a hard disk. The first application program may be any application program having codes. The first datum may be any of a text datum, a quantitative datum, an image datum, and the like.

The memory protection unit 120 is configured to store address region data Item0-Item7. It is noted that the number of address region data are taken as an example for illustration, however, in practical applications, the number of the address region data stored in the memory protection unit 120 may be any number. The random access memory 130 has at least one memory bank. The random access memory 130 may be a dynamic random access memory or a static random access memory. In some embodiments, each of the address region data Item0-Item7 stored in the memory protection unit 120 has a base address, a memory size, and a trigger condition. A detailed description of possible implementations of the address region data Item0-Item7 are shown in Table 1:

TABLE 1

| | Base address | Memory size | Trigger condition |
|---|---|---|---|
| Item0 | 0x8010, 0000 | 128k | Execute/Access |
| Item1 | 0x8012, 0000 | 128k | Execute/Access |
| Item2 | 0x8014, 0000 | 128k | Execute/Access |
| Item3 | 0x8016, 0000 | 128k | Execute/Access |
| Item4 | 0x8018, 0000 | 128k | Execute/Access |
| Item5 | 0x801a, 0000 | 128k | Execute/Access |
| Item6 | 0x801c, 0000 | 128k | Execute/Access |
| Item7 | 0x801e, 0000 | 128k | Execute/Access |

In the embodiment shown in Table 1, memory sizes of the address region data Item0-Item7 are all 128 k respectively. The trigger conditions are executing/accessing memory blocks that use base addresses of the address region data Item0-Item7 as first addresses and that occupy the memory size. Take Item0 for example, trigger condition for Item0 is executing/accessing memory blocks at 0x8010,0000-0x8010,ffff. Similarly, trigger conditions for Item1-Item7 are respectively executing/accessing memory blocks at 0x8012,0000-0x8013,ffff, 0x8014,0000-0x8015, ffff, 0x8016,0000-0x8017, ffff, 0x8018,0000-0x8019,ffff, 0x801a,0000-0x801b,ffff, 0x801c,0000-0x801d,ffff and 0x801e,0000-0x801, f,ffff. In other embodiments, the memory sizes of the address region data Item0-Item7 may be different from one another. Numerical values of the memory sizes may be any number.

The central processing unit 140 is configured to execute/access the first application program/datum in the flash memory 110 through the random access memory 130 according to at least one address datum A1. If the address datum A1 matches one of the address region data Item0-Item7, the memory protection unit 120 generates a corresponding error signal El to the central processing unit 140. The central processing unit 140 loads the first application program/datum stored in the flash memory 110 into a memory bank of the random access memory 130 according to a positioning condition of a matched address region datum Item0-Item7.

In greater detail, the central processing unit 140 may be a central processing unit with logical arithmetic functions. The address datum A1 may represent a physical address or a virtual address. A virtual address is taken as an example in subsequent description. If the central processing unit 140 needs to execute/access the first application program/datum in the flash memory 110, the central processing unit 140 must first load all or part of the code of the first application program/datum into the memory bank of the random access memory 130, and then access the loaded first application program/datum from the memory bank of the random access memory 130.

Specifically, in the present embodiment, at least one memory bank of the random access memory 130 has a plurality of physical addresses simultaneously corresponding to the memory blocks that have the base addresses of the address region data Item0-Item7 as the first addresses and that occupy the memory size. For example with numerical values, it is assumed that the random access memory 130 has a plurality of memory banks, one of the memory banks has a capacity of 128 k, and the memory bank has a physical address of0×0010,0000-0x0011,ffff. It is also assumed that there is a virtual address of 0x8010,0000 that corresponds to the physical address of 0x0010,0000. Since the capacity of the memory bank is only 128 k, for the central processing unit 140, either accessing/executing codes at the virtual address of 0x8010,0000 or accessing codes at the virtual address of 0x8012,0000 can be regarded as accessing/executing the code at the physical address of 0x0010,0000 in the memory bank. Hence, if the address datum A1 matches one of the address region data Item0-Item7, for example, if the address datum A1 is 0x8010,5566 that falls into the memory blocks at 0x8010,0000-0x8011,ffff and matches the address region data Item0, or if the address datum A1 is 0x8012,0689 that falls into the memory blocks at 0x8012,0000-0x8013,ffff and matches the address region data Item1, the memory protection unit 120 generates the corresponding error signal E1 to the central processing unit 140. It should be added that the positioning conditions of the address region data Item0-Item7 may be, for example, loading the codes in the flash memory 110 corresponding to the address region data Item0-Item7 into the memory bank of the random access memory 130. Therefore, the central processing unit 140 is able to load part of the codes of the first application program/datum corresponding to the matched address region datum (such as Item0) in the flash memory 110 into the memory bank of the random access memory 130.

It should be added that, in the above embodiment, a sum of the memory sizes of the address region data Item0-Item7 is larger than the capacity of the memory bank. As for the above example, the sum of the memory sizes of the address region data Item1-Item7 is 1024 k that is larger than the capacity of the memory bank, i.e., 128 k. In other embodiments, the memory size of each of the address region data Item0-Item7 may be 64 k, thus the sum thereof is 512 k, which is still larger than the capacity 128 k of the memory bank.

In some embodiments, the central processing unit 140 erases the positioning condition of the matched address region datum after loading the first application program/datum into the memory bank of the random access memory 130, and continues to execute/access the first application program/datum loaded into the random access memory 130 according to the address datum A1. In greater detail, after the first application program/datum is loaded into the memory bank of the random access memory 130, the central processing unit 140 can directly execute/access the memory bank in the random access memory 130 according to the address datum A1, and therefore the central processing unit 140 erases the positioning condition of the matched address region datum (such as Item0) at this moment so that the central processing unit 140 no longer jumps to the flash memory 110.

In some embodiments, the first application program/datum has region codes C0-C7 respectively corresponding to the address region data Item0-Item7. The central processing unit 140 loads the corresponding region code according to the matched address region datum. That is, the codes of the first application program/datum stored in the flash memory 110 is in greater amount. If the central processing unit 140 needs to execute/access the first application program/datum, the central processing unit 140 loads the corresponding region codes (such as C0) into the memory bank of the random access memory 130 according to the matched address region datum (such as Item0). If the central processing unit 140 needs to switch to execute/access the first application program/datum, the central processing unit 140 loads the corresponding region code (such as C1) into the memory bank of the random access memory 130 according to the matched address region datum (such as item1).

In some embodiments, if the central processing unit 140 switches to execute/access between the region codes C0-C7 in the first application program/datum, the central processing unit 140 erases the positioning condition of a currently matched address region datum after loading the first application program/datum into the at least one memory bank of the random access memory 130, and continues to execute/access the first application program/datum loaded into the random access memory 130 according to the address datum A1 after recovering the positioning condition of another address region datum which is previously erased. As mentioned above, after the first application program/datum is loaded into the memory bank of the random access memory 130, the central processing unit 140 erases the positioning condition of the matched address region datum (such as Item0) so that the central processing unit 140 no longer jumps to the flash memory 110. Hence, in the present embodiment, the first application program/datum includes the region codes C0-C7. If the central processing unit 140 needs to switch from executing/accessing the region code C to executing/accessing the region code C1. the central processing unit 140 erases the positioning condition of the matched address region datum (such as Item1) after loading the first application program/datum into the memory bank of the random access memory 130. On the other hand, the central processing unit 140 recovers the positioning condition of another address region datum (such as Item0) that is previously erased to facilitate the central processing unit 140 to load the region code CO into the memory bank of the random access memory 130 again if the central processing unit 140 switches to execute/access the region code C0 again. In this manner, the present disclosure allows a chip without functions of a memory management unit (MMU) to utilize the property of the memory protection unit to expand the using of memory address space without affecting normal compilation and running of the codes.

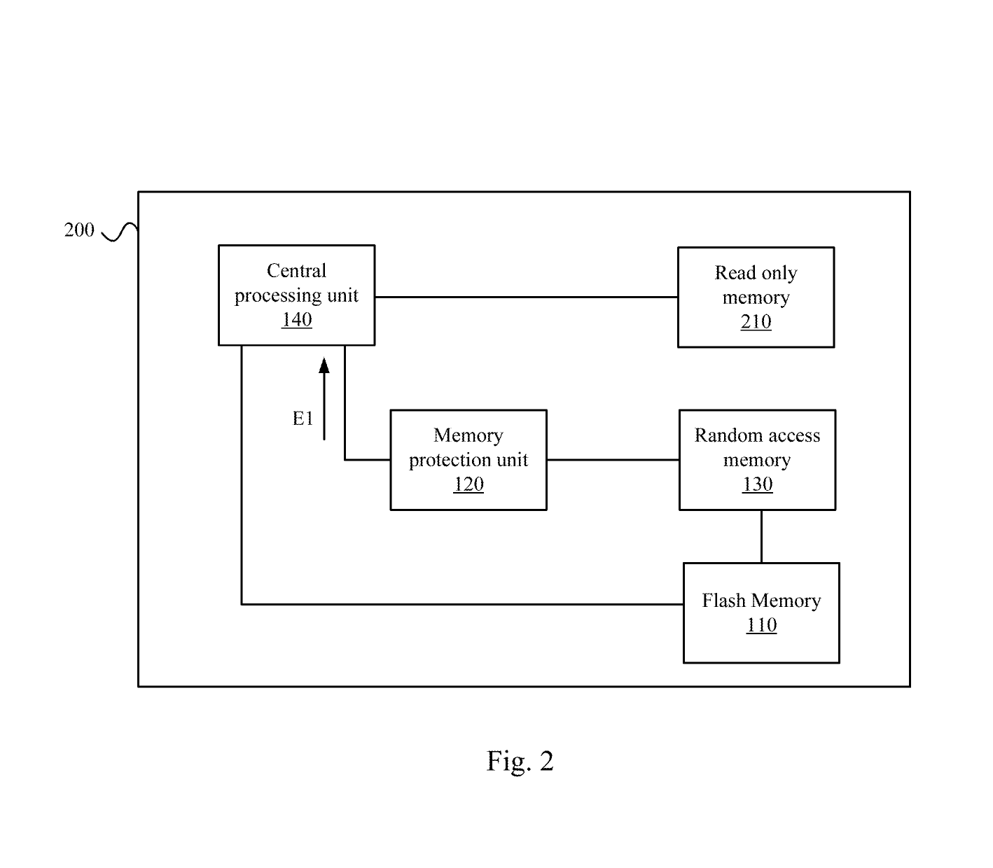

In some embodiments, the electronic apparatus further includes a read only memory 210. Reference is now made to FIG. 2. FIG. 2 depicts a schematic diagram of an electronic apparatus 200 according to another embodiment of the present disclosure. The read only memory 210 is configured to store at least one second application program/datum. The central processing unit 140 executes/accesses the second application program/datum in the read only memory 210 according to the address datum A1. If the central processing unit 140 switches from the second application program/datum to executing/accessing the first application program/datum and the address datum A1 matches one of the address region data Item0-Item7, the memory protection unit 120 generates the error signal E1 correspondingly to the central processing unit 140. The central processing unit 140 loads the first application program/datum stored in the flash memory 110 into the random access memory 130 according to the positioning condition of the matched address region datum.

In greater detail, the second application program/datum stored in the read only memory 210 may be codes of an operating system or initialization codes that needs to be executed/accessed when a system on chip is starting up. Hence, in the present embodiment, the central processing unit 140 first executes/accesses the second application program/datum in the read only memory 210. If the central processing unit 140 needs to execute/access the first application program/datum in the flash memory 110, as mentioned previously, the first application program/datum in the flash memory 110 needs to be loaded into the random access memory 130 first. Similarly, the corresponding error signal E1 is generated to the central processing unit 140 by the memory protection unit 120, and the central processing unit 140 then loads all or part of the codes of the first application program/datum according to the positioning condition of the matched address region datum (such as Item0).

It should be added that, in some embodiments, after the error signal E1 is generated to the central processing unit 140, the central processing unit 140 determines whether the matched address region datum has the positioning condition. If the matched address region datum has the positioning condition, as mentioned above, the first application program/datum is loaded into the random access memory 130. In contrast, if the matched address region datum does not have the positioning condition, it means that the matched address region datum is not allowed to be executed/accessed, which may be regarded as the address region data that needs to be protected, and therefore the central processing unit 140 stops accessing the address datum A1 at this moment.

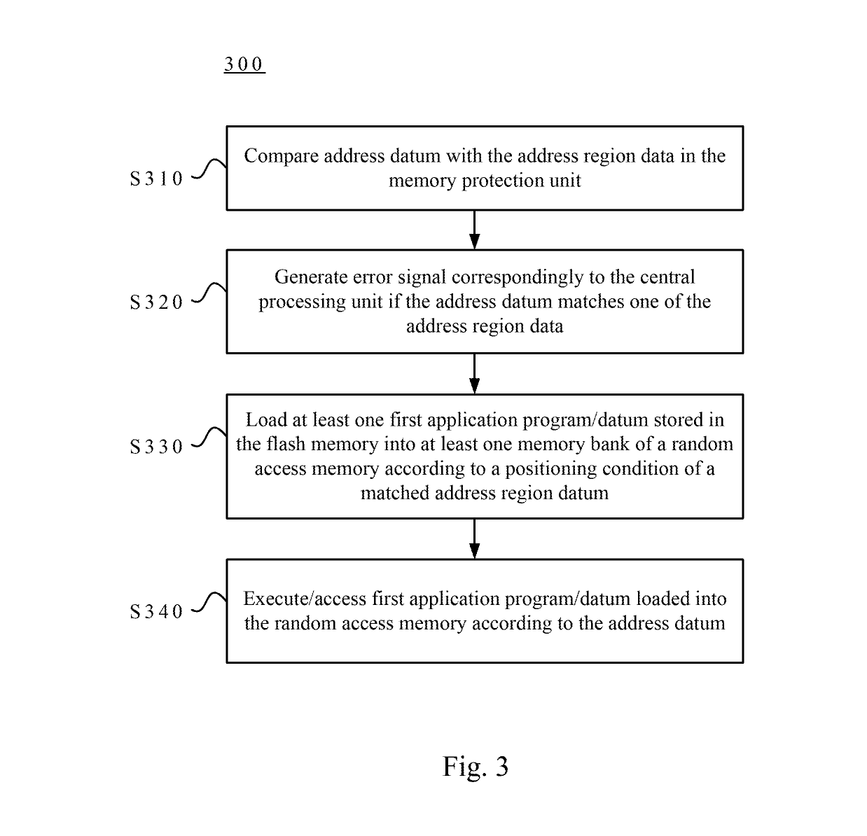

The present disclosure further discloses a control method as shown in FIG. 3. FIG. 3 depicts a schematic diagram of a control method 300 according to one embodiment of the present disclosure. The control method 300 is applicable to the above-mentioned electronic apparatuses 100, 200 or some other equivalent electronic apparatuses. In the present embodiment, the control method 300 is applied to the electronic apparatus 100 as an example.

In step S310, the address datum A1 is compared with the address region data Item0-Item7 in the memory protection unit 120.

In step S320, if the address datum A1 matches one of the address region data Item0-Item7, the corresponding error signal E1 is generated to the central processing unit 140.

In step S330, at least one first application program/datum stored in the flash memory 110 is loaded into at least one memory bank of a random access memory according to a positioning condition of a matched address region datum.

In step S340, the first application program/datum loaded into the random access memory 130 is executed/accessed according to the address datum A1.

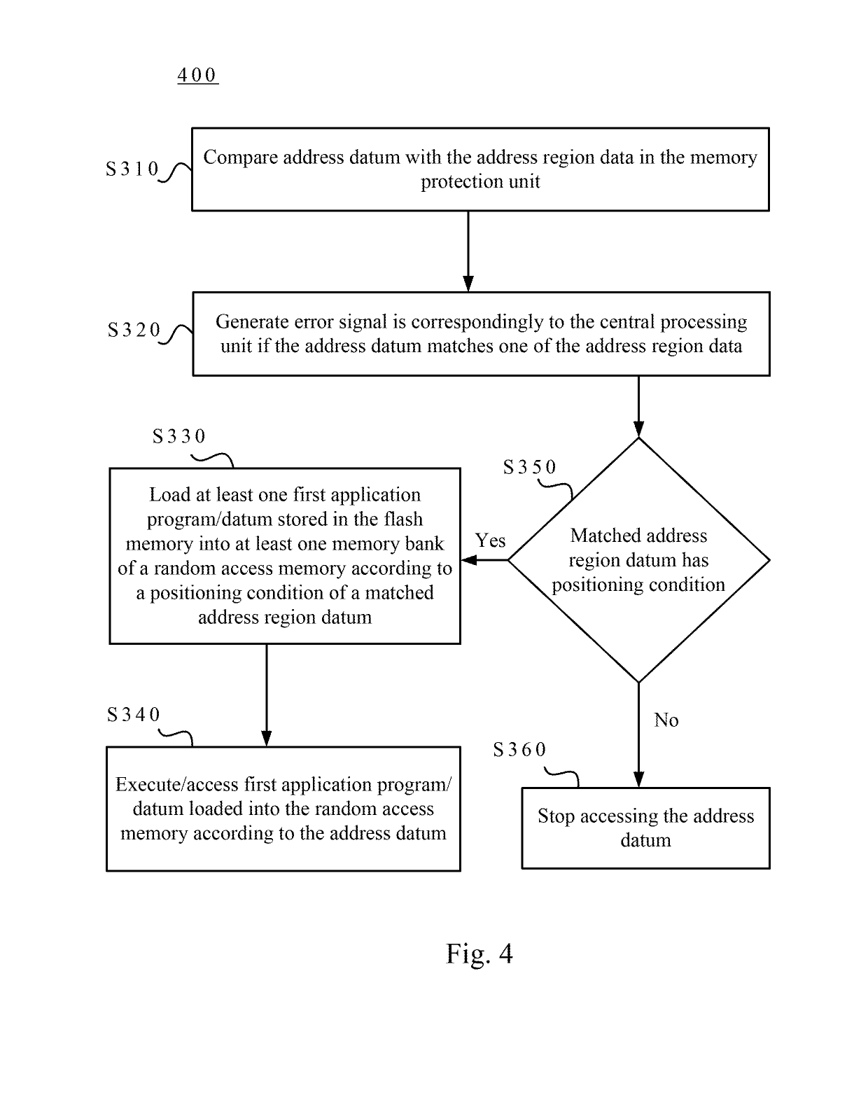

It should be added that, in some embodiments, the control method further includes steps S350 and S360. Reference is made to FIG. 4. FIG. 4 depicts a schematic diagram of a control method 400 according to another embodiment of the present disclosure. It can be seen from the figure that the difference between the control method 400 and the control method 300 is that step S350 is performed instead after performing step S320. In step S350: a determination is made regarding whether the matched address region datum has the positioning condition. If the matched address region datum has the positioning condition, step S330 is performed subsequently. If the matched address region datum does not have the positioning condition, step S360 is performed to stop accessing the address datum A1.

In conclusion, the present disclosure allows a chip without functions of a memory management unit (MMU) to utilize the property of the memory protection unit to expand the using of memory address space without affecting the normal compilation and running of the codes.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of the present disclosure provided they fall within the scope of the following claims and their equivalents.

What is claimed is:

1. An electronic apparatus comprising:
a flash memory, configured to store at least one first application program/datum;
a memory protection unit, configured to store a plurality of address region data;
a random access memory, having at least one memory bank; and
a central processing unit, configured to execute/access the at least one first application program/datum in the flash memory through the random access memory according to at least one address datum, wherein if the at least one address datum matches one of the address region data, the memory protection unit generates an error signal to the central processing unit, and the central processing unit loads the at least one first application program/datum stored in the flash memory into the at least one memory bank of the random access memory according to a positioning condition of a matched address region datum.

2. The electronic apparatus of claim 1, wherein each of the address region data has a base address, a memory size, and a trigger condition, the trigger condition is executing/accessing memory blocks that use the base address of each of the address region data as a first address and that occupy the memory size.

3. The electronic apparatus of claim 2, wherein the at least one memory bank has a plurality of physical addresses simultaneously corresponding to the memory blocks that use the base address of each of the address region data as the first addresses and that occupy the memory size, and a sum of the memory sizes of the address region data is larger than a capacity of the at least one memory bank.

4. The electronic apparatus of claim 1, further comprising:
a read only memory, configured to store at least one second application program/datum, wherein the central processing unit executes/accesses the at least one second application program/datum in the read only memory according to the at least one address datum; if the central processing unit switches from the at least one second application program/datum to executing/accessing the at least one first application program/datum, and if the at least one address datum matches one of the address region data, the memory protection unit generates the corresponding error signal to the central processing unit, the central processing unit loads the at least one first application program/datum stored in the flash memory into the random access memory according to the positioning condition of the matched address region datum.

5. The electronic apparatus of claim 1, wherein the central processing unit erases the positioning condition of the matched address region datum after loading the at least one first application program/datum into the at least one memory bank of the random access memory, and continues to execute/access the at least one first application program/datum loaded into the random access memory according to the at least one address datum.

6. The electronic apparatus of claim 5, wherein the at least one first application program/datum has a plurality of region codes respectively corresponding to the address region data, the central processing unit loads the corresponding region codes according to the matched address region datum.

7. The electronic apparatus of claim 6, wherein if the central processing unit switches to execute/access between the region codes in the at least one first application program/datum, the central processing unit erases the positioning condition of a currently matched address region datum after loading the at least one first application program/datum into the at least one memory bank of the random access memory, and continues to execute/access the at least one first application program/datum loaded into the random access memory according to the at least one address datum after recovering the positioning condition of another address region datum that is previously erased.

8. A control method applicable to an electronic apparatus, the electronic apparatus comprising a flash memory, a memory protection unit, a random access memory, and a central processing unit, the control method comprising:
comparing at lest one address datum with a plurality of address region data in the memory protection unit;
generating an error signal to the central processing unit if the at least one address datum matches one of the address region data;
loading at least one first application program/datum stored in the flash memory into at least one memory bank of the random access memory according to a positioning condition of a matched address region data; and
executing/accessing the at least one first application program/datum loaded into the random access memory according to the at least one address datum.

9. The control method of claim 8, wherein the electronic apparatus further comprises a read only memory, the control method further comprises:
executing/accessing at least one second application program/datum in the read only memory according to the at least one address datum;
switching from the at least one second application program/datum to executing/accessing the at least one first application program/datum;
generating the corresponding error signal to the central processing unit if the at least one address datum matches one of the address region data; and
loading the at least one first application program/datum stored in the flash memory into the random access memory according to the positioning condition of the matched address region datum.

10. The control method of claim 8, further comprising:
erasing the positioning condition of the matched address region datum after loading the at least one first application program/datum into the at least one memory bank of the random access memory; and
continuing to execute/access the at least one first application program/datum loaded into the random access memory according to the at least one address datum.
